(19) United States
(12) Patent Application Publication
(10) Pub. No.: US 2014/0086504 A1
(43) Pub. Date: Mar. 27, 2014

(54) ENCODING APPARATUS, DECODING APPARATUS, AND SWITCH APPARATUS

(71) Applicant: Sony Corporation, Tokyo (JP)

(72) Inventor: Hiroshi Arai, Kanagawa (JP)

(73) Assignee: Sony Corporation, Tokyo (JP)

(21) Appl. No.: 14/030,022

(22) Filed: Sep. 18, 2013

(30) Foreign Application Priority Data
Sep. 25, 2012 (JP) 2012-210881

(51) Int. Cl. G06T 9/00

(52) U.S. Cl. CPC G06T 9/005
USPC 382/246

(57) ABSTRACT

Provided is an encoding apparatus including a frequency decomposition unit, a superimposition processing unit, and a transmission unit. The frequency decomposition unit is configured to frequency-decompose image data into a low-frequency-component: image and a plurality of high-frequency-component images. The superimposition processing unit is configured to superimpose the plurality of frequency-decomposed high-frequency-component images to generate a single superimposed high-frequency-component image. The transmission unit is configured to transmit the low-frequency-component image and the superimposed high-frequency-component image as compressed image data.

### CROSS REFERENCE TO RELATED APPLICATIONS

The present disclosure contains subject matter related to that disclosed in Japanese Priority Patent Application JP 2012-210881 filed in the Japan Patent Office on Sep. 25, 2012, the entire content of which is hereby incorporated by reference.

### BACKGROUND

The present disclosure relates to an encoding apparatus, a decoding apparatus, and a switch apparatus with which high-resolution image data can be favorably transmitted,

In recent, years, along with progresses in high-resolution television broadcasts, high-resolution images of 4K Hi-Vision, 8K Super Hi-Vision, and the like are starting to be used.

While 4K Hi-Vision and 8K Super Hi-Vision use compression-based transmission, image processing for 4K Hi-Vision and 8K Super Hi-Vision is still baseband (non-compression) processing.

For example, Japanese Patent Application Laid-open No. 2004-326447 (hereinafter, referred to as Patent Document 1) discloses a technique on an image synthesizing device that is capable of synthesizing and encoding two images at a time a JPEG-2000 encoded signal is EBCOT-decoded. The image synthesizing device disclosed in Patent Document 1 decodes an encoded code stream encoded according to JPEG-2000 specifications and generates a quantized coefficient for each code block. In a cross fade part, quantized coefficients are multiplied by coefficients α(t) and (1−α(t)) by adders, and the resultants are added by an adder so that a cross fade quantized coefficient is obtained. The obtained cross fade quantized coefficient is encoded, and an eventually-obtained encoded code stream is output. The image synthesizing device disclosed in Patent Document 1 bears an effect that two encoded code streams are easily and efficiently synthesized with a small memory usage.

### SUMMARY

An amount of high-resolution image data of 4K Hi-Vision, 8K Super Hi-Vision, and the like is massive. When general signal processing is carried out, as image processing, on a high-resolution image in an encoding apparatus, a switch apparatus, and a decoding apparatus, a total operation amount for the signal processing also becomes massive. Nowadays, while there is a remarkable progress in speed-up of an operational processing apparatus such as a CPU, an LSI (Large Scale Integration) of a larger scale or the like has been necessary. As a result, a scale enlargement of requisite hardware resources and an increase in power consumption have been inevitable.

In view of the circumstances as described above, there is a need for an encoding apparatus, a decoding apparatus, and a switch apparatus with which hardware resources for signal processing can be downsized.

(1) According to an embodiment of the present disclosure, there is provided an encoding apparatus including: a frequency decomposition unit configured to frequency-decompose image data into a low-frequency-component image and a plurality of high-frequency-component images; a superimposition processing unit configured to superimpose the plurality of frequency-decomposed high-frequency-component images to generate a single superimposed high-frequency-component image; and a transmission unit configured to transmit the low-frequency-component image and the superimposed high-frequency-component image as compressed image data.

In this embodiment, a data amount is compressed by superimposing the plurality of high-frequency components obtained by frequency-decomposing the original image to obtain a single superimposed high-frequency component. Since the data amount is compressed by superimposition, superimposition and reverse superimposition algorithms are simple as compared to a compression performed by a replacement with a totally different code such as Huffman coding. Therefore, hardware resources for signal processing can be downsized.

(2) In the encoding apparatus, the superimposition processing unit may perform the superimposition. after selecting, out of the plurality of high-frequency-component images, a maximum value among relevant pixels as a pixel value of the superimposed high-frequency-component image.

With this structure, in the superimposition processing, a pixel having a maximum value out of the plurality of pixels as superimposition targets is selected as a pixel value of the superimposed high-frequency-component. Therefore, it is possible to leave, out of the high-frequency components, the maximum value, that is, the most meaningful pixel value after the superimposition processing.

(3) The encoding apparatus may further include a scramble processing unit configured to perform scramble processing on each of the plurality of frequency-decomposed high-frequency-component images.

In the high-frequency-component images obtained by frequency-decomposing the original image, a large value is set at the relevant pixel position of each image in many cases. In this regard, in this embodiment, the pixel positions of the high-frequency components are scrambled, that is, rearranged on the image before the superimposition processing. With this structure, in performing the superimposition processing, a situation that values other than the maximum value are thrown away due to large values in the high-frequency components colliding with one another can be prevented from occurring to some extent.

(4) In the encoding apparatus, the scramble processing unit may perform the scramble processing by replacing, according to mutually-different rules respectively allocated to the plurality of frequency-decomposed high-frequency-component images, a pixel position in the high-frequency-component image.

With this structure, since the rules that differ for each of the high-frequency components are used in performing the scramble processing, even when a large value comes to a relevant pixel position in the high-frequency-component images obtained by frequency-decomposing the original image, large pixel values can be scattered to different positions. As the rules, for example, considering numerals included in a random number table as new coordinates, the pixel positions can be replaced.

(5) In the encoding apparatus, the superimposition processing unit may perform, when there are a plurality of values equal to or larger than a predetermined threshold value among values of the relevant pixels, the superimposition after selecting a maximum value as a pixel value of the. superimposed high-frequency-component image and subjecting the rest of the values equal to or larger than the threshold value to the scramble processing again by the scramble processing unit.

Since a large value often comes to the relevant pixel position in the high-frequency-component images obtained by frequency-decomposing the original image, large values may be scattered using random number tables that differ for each component. However, the values do not always come to positions at which values that are to be left after the superimposition processing, that is, values equal to or larger than the predetermined threshold value, do not collide with one another by a single scramble processing.

In this regard, in this embodiment, a judgment is made on whether there is a plurality of pixels as superimposition targets whose pixel values are equal to or larger than a threshold value. After a maximum value among the pixel values is set as a pixel value of the superimposed high-frequency component, the scramble processing is carried out again on the remaining pixels out of the processing target pixels using a different random number table to perform the superimposition processing again. The scramble processing and the superimposition processing that are carried out again are repeated on the pixel values equal to or larger than the threshold value. Therefore, even when the pixel values equal to or larger than the threshold value collide with one another, by repeating the scramble processing and the superimposition processing, data can be compressed without wasting the large values. Moreover, in a case where all the pixel values of the components to be superimposed are extremely small, by passing over the coordinate position of the superimposed high-frequency component to a reprocessed large value, a compression efficiency can be raised.

(6) According to an embodiment of the present disclosure, there is provided a decoding apparatus, including; an input unit configured to input compressed image data transmitted from an encoding apparatus including a frequency decomposition unit that frequency-decomposes image data into a low-frequency-component image and a plurality of high-frequency-component images, a superimposition processing unit that superimposes the plurality of frequency-decomposed high-frequency-component images to generate a single superimposed high-frequency-component image, and a transmission unit that transmits the low-frequency-component image and the superimposed high-frequency-component image as the compressed image data; a separation processing unit configured to separate the input compressed image data into the low-frequency-component image and the superimposed high-frequency-component image; a reverse superimposition processing unit configured to subject the separated superimposed high-frequency-component image to reverse superimposition processing to obtain the plurality of high-frequency-component images; a frequency reverse decomposition unit configured to reversely frequency-decompose the separated low-frequency-component, image and the plurality of high-frequency-component images obtained by the reverse superimposition processing; and an output unit configured to output image data generated by the frequency reverse decomposition.

In the encoding apparatus, the compressed image data is generated by carrying out the frequency decomposition processing and the superimposition processing on the image data. On the other hand, in the decoding apparatus, reverse processing, that is, reverse superimposition processing is carried out on the compressed image data to reproduce the image data. Since an algorithm of the reverse superimposition processing in the decoding apparatus is simple, hardware resources for signal processing can be downsized.

(7) According to an embodiment of the present disclosure, there is provided a switch apparatus, including: an input unit configured to input a plurality of pieces of compressed image data transmitted from a plurality of encoding apparatuses each including a frequency decomposition unit that frequency-decomposes image data into a low-frequency-component image and a plurality of high-frequency-component images, a superimposition processing unit that superimposes the plurality of frequency-decomposed high-frequency-component images to generate a single superimposed high-frequency-component image, and a first transmission unit that transmits the low-frequency-component image and the superimposed high-frequency-component image as the compressed image data; a select unit configured to select a plurality of pieces of compressed image data from the plurality of pieces of input compressed image data; a signal processing unit configured to perform processing for a synthesis on the plurality of selected pieces of compressed image data; and a second transmission unit configured to transmit the processed compressed image data.

In this embodiment, the signal processing unit carries out the processing for synthesizing the images on the compressed image data transmitted from the plurality of encoding apparatuses in the compressed state. Therefore, time and effort required for expanding the compressed image data received from the encoding apparatus and compressing it again after the image processing can be omitted. As a result, hardware used for the expansion and compression becomes unnecessary, and thus hardware resources for signal processing can be downsized.

(8) In the switch apparatus, the signal processing unit may separate the compressed image data into the low-frequency component, the superimposed high-frequency component, and a boundary component that is obtained when synthesizing images included in the plurality of pieces of compressed image data, and perform the processing for a synthesis for each of the components.

In this embodiment, in performing image synthesis processing such as Wipe, PinP, Chroma Key, and Luminance Key, the compressed image data including two images to be used for the synthesis is separated into the low-frequency component, the high-frequency component, and the boundary component, to thus carry out image processing using optimal processing methods having balanced image quality and hardware resources. Therefore, hardware resources for signal processing can be downsized.

(9) In the switch apparatus, the plurality of encoding apparatuses may each include a scramble processing unit that replaces, according to mutually-different rules respectively allocated to the plurality of frequency-decomposed high-frequency-component images, a pixel position in the high-frequency-component image, and the signal processing unit may perform the processing for a synthesis by specifying, with respect to the plurality of superimposed high-frequency-component images, the pixel position from before the scramble processing using the rules.

In this embodiment, since the scramble processing is carried out when performing the image synthesis processing using superimposed high-frequency components, appropriate image synthesis processing cannot be carried out as it is. In this regard, using the rule used when carrying out the scramble processing (e.g., random number table), original coordinates obtained before scrambling the pixels to be processed are obtained, and the image processing is carried out according to the original coordinates. Since the pixel positions are replaced based on a simple rule in the scramble processing, the processing of obtaining the original coordinates is simple as compared to Huffman coding and the like. Therefore, hardware resources for signal processing can be downsized.

(10) In the switch apparatus, the signal processing unit may perform the scramble processing by performing frequency reverse decomposition processing on the boundary component, performing the processing for a synthesis as in a case of a baseband, and performing the frequency decomposition again.

In this embodiment, in performing an image synthesis, for a part to be a boundary of the two images to be synthesized, only the components at the boundary are restored to a state close to the original image as much as possible and subjected to the image processing that is the same as the baseband processing before restoring it to the compressed image data to perform processing more accurately. As compared to the case where such processing has been carried out on the entire compressed image data in the past, by narrowing the operation target to only the boundary component, an operation amount can be reduced, and hardware resources for signal processing can be downsized.

As described above, according to the embodiments of the present disclosure, hardware resources for signal processing can be downsized, and power consumption can be cut.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a photograph of a 4K Hi-Vision-size original image;

FIG. 2 is a diagram showing a state where the original image is divided into a low-frequency component on the upper left, a horizontal-direction high-frequency component on the lower left, a vertical-direction high-frequency component on the upper right, and a diagonal-direction high-frequency component on the lower right;

FIG. 3 is a diagram showing a state where 10 pixels are subjected to scramble processing and a state where the once-scrambled pixels are subjected to reverse scramble to be restored to the original state;

FIG. 4 is a diagram showing an example of a program for generating a random number table Rand and a reverse random number table Rev_Rand;

FIG. 5 is a diagram showing a state where an area ID is allocated to each of high-frequency components after frequency decomposition, and superimposition processing of the high-frequency components is carried out;

FIG. 6 is a diagram showing an example of the allocation of the area ID;

FIG. 7 is a diagram showing an example of the allocation of the area ID;

FIG. 8 is a diagram showing an example of the allocation of the area ID;

FIG. 9 is a block diagram showing a structure of an encoding apparatus;

FIG. 10 is a flowchart showing a flow of encoding processing in the encoding apparatus;

FIG. 11 is a block diagram showing a structure of a decoding apparatus;

FIG. 12 is a flowchart showing a flow of decoding processing in the decoding apparatus;

FIG. 13 is a block diagram showing a structure of a switch apparatus according to an embodiment of the present disclosure;

FIG. 14 is a block diagram showing a structure of a switch apparatus of the related art;

FIG. 15 is a diagram showing a positional relationship of components when performing WIPE processing as image processing; and

FIG. 16 is a flowchart showing a flow of processing of a compressed signal processing unit.

### DETAILED DESCRIPTION OF EMBODIMENTS

### First Embodiment

Hereinafter, an embodiment of the present disclosure will be described with reference to the drawings.

(Outline and Effect of Present Disclosure)

Among an encoding apparatus, a switch apparatus, and a decoding apparatus that handle high-resolution images used in 4K Hi-Vision, 8K Super Hi-Vision, and the like, image data has been compressed for an image transmission by Huffman coding from the past. Therefore, in performing signal processing for an image synthesis in the switch apparatus or the like, the Huffman-coded image data is temporarily decoded and then subjected to the signal processing. As a result, hardware for encoding or large-scale hardware resources as the hardware for encoding have been necessary.

Moreover, since encoding uses codes of variable lengths in the Huffman coding, in a worst case where an image of an extremely complicated picture is to be encoded, the encoded data amount exceeds the data amount obtained before the encoding, to thus lead to a compression failure.

To avoid such a failure, high-frequency components are intentionally cut in the Huffman coding, and when compressing an image of a complicated picture, a survival rate of the high-frequency components drops to about 7%.

In contrast, in scramble superimposition encoding of the present disclosure, data, is compressed by superimposing a plurality of high-frequency components obtained by frequency decomposition to obtain a single superimposed high-frequency component. It should be noted that the superimposition used herein is performed by comparing relevant elements of the high-frequency components as superimposition targets and selecting a maximum value as a value of the superimposed high-frequency component.

Therefore, codes have a fixed length, and a compression failure is not caused when compressing an image of a complicated picture. Furthermore, since the codes have a fixed length, system synchronization can be made with ease.

Further, the survival rate of the high-frequency components is 14% under the same condition as the Huffman coding, and an information amount of the high-frequency components that remain after decoding is twice as large as that of the Huffman coding.

Also when performing signal processing for an image synthesis in the switch apparatus, the signal processing can be performed without decoding the image data in the superimposed and compressed state. Therefore, hardware for decoding is unnecessary, and the hardware structure can be made simple.

It should be noted, that in performing the superimposition processing in the scramble superimposition encoding of the present disclosure, the elements of the high-frequency components are rearranged (scrambled) using a random number table (same number does not appear repetitively) before the superimposition so that the high-frequency components having large values do not collide with one another.

(Mechanism of Scramble Superimposition Encoding)

Here, a basic mechanism of the scramble superimposition encoding will be described. It should be noted that here, wavelet conversion processing will be taken as an example of frequency decomposition processing as first processing carried out on image data as a processing target.

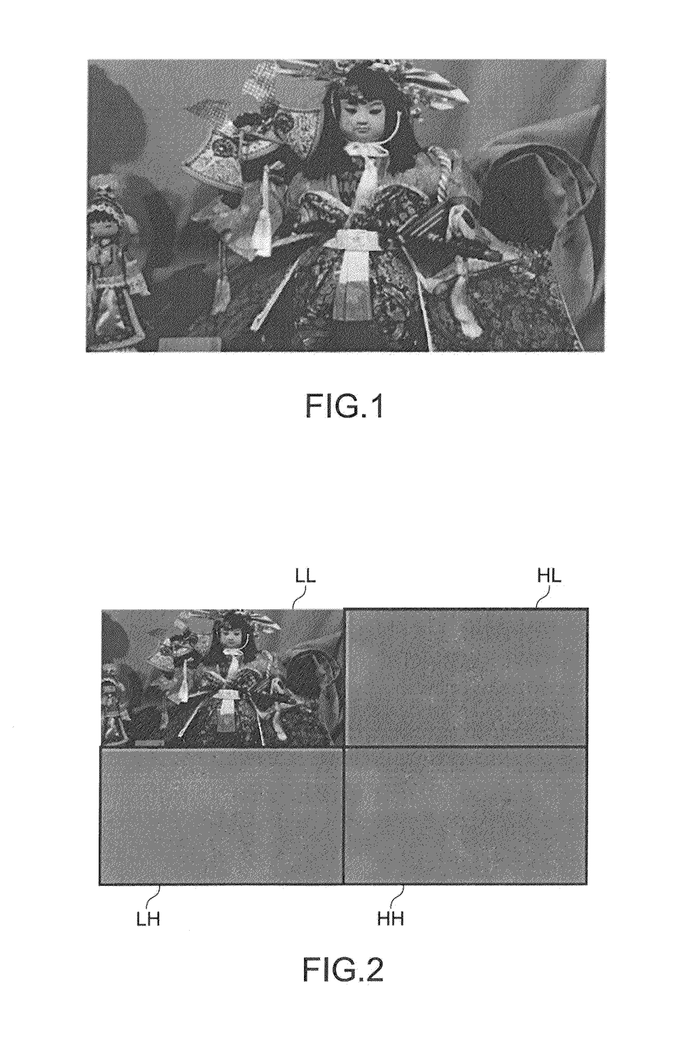

(1) First, an original image is subjected to a wavelet conversion. FIG. 1 is a photograph of a 4K Hi-Vision-size original image. By the wavelet conversion, the original image is divided into a low-frequency component (LL) image on the upper left, a horizontal-direction high-frequency component (hereinafter, referred to as LH component) image on the lower left, a vertical-direction high-frequency component (hereinafter, referred to as HL component) image on the upper right, and a diagonal-direction high-frequency component (hereinafter, referred to as HH component) image on the lower right as shown in FIG. 2. The size of the images of the respective components is an HD (High Definition) size.

(2) Next, the scramble processing is carried out for the high-frequency components. At this time, use of different random number tables for the high-frequency components is an important key. Since large values are often located at the same position in the three high-frequency components, different random number tables are used for scattering the values.

Further, the numbers in the random number table not overlapping one another is another important key. The numbers in the random number table indicate positions to which the high-frequency components move. Therefore, if the numbers overlap, a plurality of values move to the same position, and correct, processing cannot be performed in decoding.

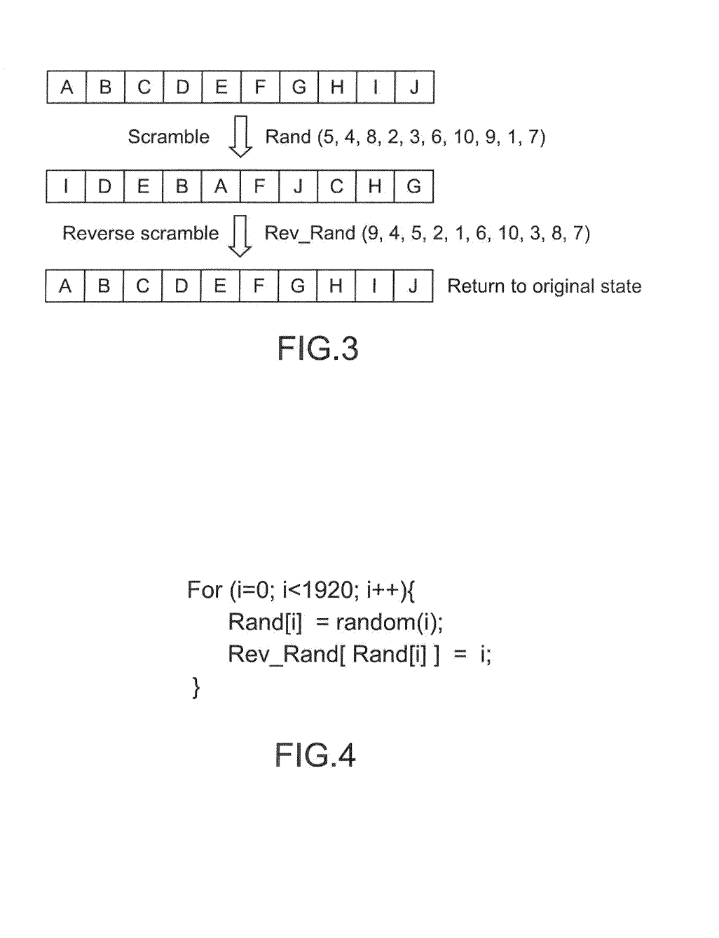

FIG. 3 is a diagram showing a state where 10 pixels are subjected to the scramble processing and a state where the once-scrambled pixels are subjected to reverse scramble to be restored to the original state.

In the figure, first, 10 pixels A to J are arranged in order. Then, the pixels are rearranged and scrambled using random numbers (5, 4, 8, 2, 3, 6, 10, 9, 1, and 7) that do not overlap in a random number table Rand. The arrangement order of the scrambled pixels is I, D, E, B, A, F, J, C, H, and G from the left-hand side.

For example, the pixel A originally positioned at the very left is rearranged to a fifth position from the left based on the random number value “5”.

Next, reverse scramble processing is carried out. In the reverse scramble processing, a reverse random number table Rev_Rand that has been generated when generating the random number table Rand is used. In the example of the reverse random number table Rev_Rand, the random numbers are (9, 4, 5, 2, 1, 6, 10, 3, 8, and 7).

For example, the pixel E as the third pixel from the left due to the scramble is moved back to the fifth position from the left since the third numerical value in the reverse random number table Rev_Rand is “5”.

The arrangement order of the pixels A to J is restored as described above. As can be understood from the descriptions above, for restoring the scrambled pixels, the reverse random number table needs to be specified for each pixel. In this regard, a random number table ID that uniquely specifies the reverse random number table used in the reverse scramble is allocated to each pixel.

It should be noted that FIG. 4 is a diagram showing an example of a program for generating the random number table Rand and the reverse random, number table Rev_Rand. In this example, a random number table and reverse random number table used for replacing 1920 pixels included, in one line of an HD-size image obtained by performing a single wavelet conversion on a 4K High-Vision original image are generated. It should be noted that in this example, an algorithm used for preventing the numbers from overlapping one another is omitted.

(3) Subsequently, processing of superimposing pixel values at relevant positions in the high-frequency components (same coordinates in components) is carried out. For example, with a pixel value at coordinates (100, 100) in the LH component being expressed as LH (100, 100), a maximum value is selected from three pixel values of LH (100, 100), HL (100, 100), and HH (100, 100) in the superimposition processing, and the selected maximum value is set as a pixel value at coordinates (100, 100) in a superimposed high-frequency component.

Specifically, for example, assuming that, the LH-component image is a superimposed high-frequency-component image, the HL-component value is superimposed while comparing the values for each pixel. Then, the HH-component value is superimposed while comparing the values for each pixel.

By such processing, the high-frequency components corresponding to an amount of three HD-size images are put together to obtain a superimposed high-frequency component of a single HD-size image.

It should be noted that the obtained superimposed high-frequency component needs to be correctly divided into the three high-frequency components in performing decoding processing and the like. Therefore, in the superimposition processing, an ID (hereinafter, referred to as area ID) of 2 to 4 bits is allocated to each of the pixel values. A bit length of the area ID is determined based on the number of high-frequency components to be superimposed. In the example above, the original number of high-frequency components is three. Therefore, a 2-bit area ID is used. In this case, as the three area IDs, 01 can be allocated to the LH component, 00 can be allocated to the HL component, and 10 can be allocated to the HH component, for example.

The basic mechanism of the scramble superimposition encoding has been described heretofore. Although the scramble processing and the superimposition processing are carried out once in the above descriptions, the processing may be carried out a plurality of times. The structure used when carrying out the processing a plurality of times will be described later.

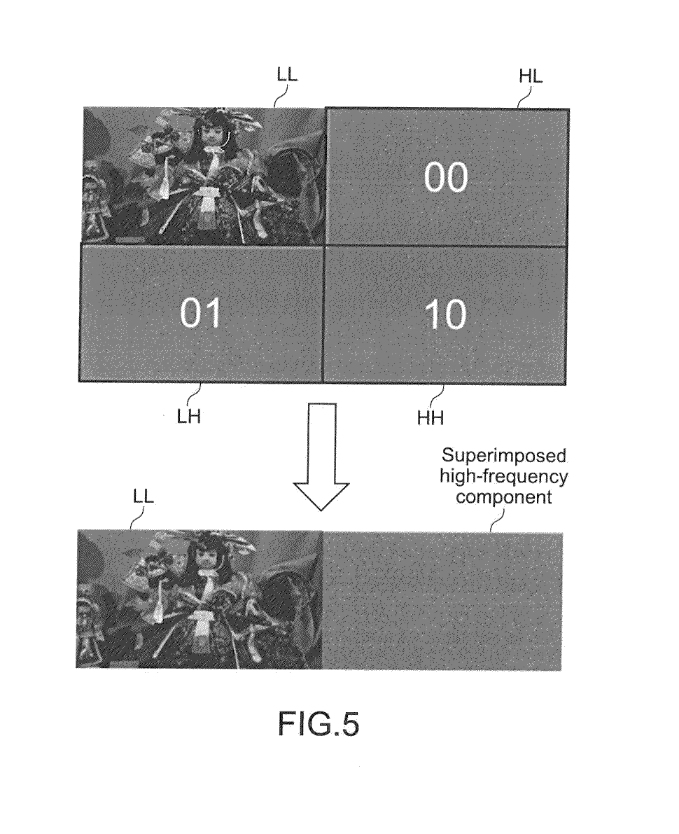

In the descriptions above, the 4K High-Vision-size original image is divided into 4 frequency components, and the HD-size low-frequency component (LL component) is left as it is without compression while the remaining 3 high-frequency components are compressed to a single HD-size superimposed high-frequency component, with the result that a compression rate as a whole is ½. FIG. 5 is a diagram showing a state where the area ID is allocated to each of the high-frequency components after frequency decomposition, and the superimposition processing of the high-frequency components is carried out after that.

(Allocation of Area IDs and Example of Division)

Next, an example of dividing the area for allocating the area IDs and a specific example of the compression rate will be described. In the example above, by compressing three HD-size high-frequency components generated by a single wavelet conversion to a single HD-size superimposed, high-frequency component, the data is compressed to ½ as a whole. Hereinafter, a different specific example will be described.

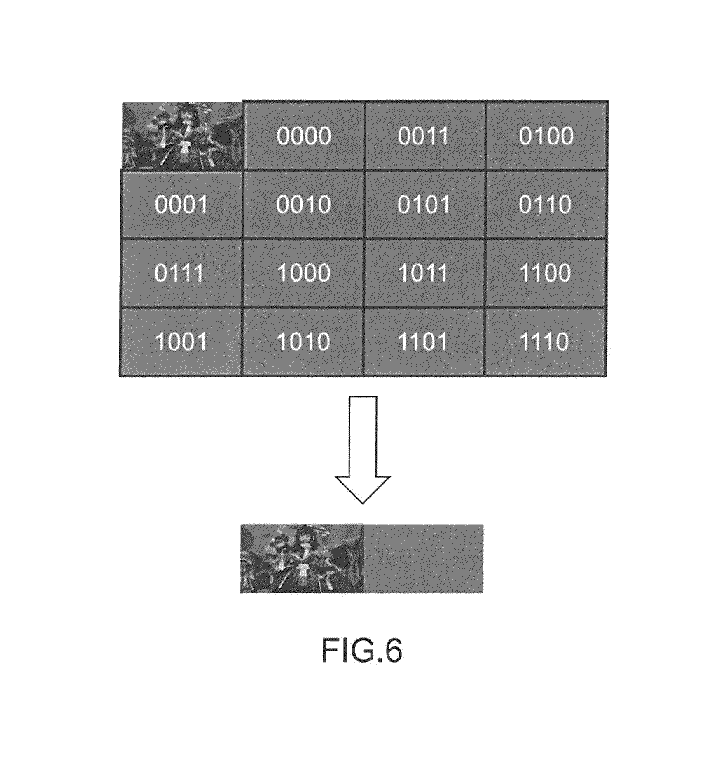

FIG. 6 is a diagram showing another example of the allocation of the area IDs. In this example, the wavelet conversion is carried out twice. With components generated after the second wavelet conversion (second layer component) being represented by LL2, HL2, LH2, and HH2, the size of LL2 as the low-frequency component is 1/16 the original image.

The high-frequency-component area of HL, LH, and HH is divided into 4, to thus obtain 15 high-frequency-component areas together with the areas of HL2, LH2, and HH2. Since the area ID is allocated to each of the 15 areas, the bit length of the area ID becomes 4 bits. The 4-bit codes shown in the areas in the figure are the example of the area IDs.

In this example, the low-frequency component (LL2) is not compressed, and the high-frequency components of the remaining 15 areas are superimposed to a single superimposed high-frequency component. Therefore, 1/15 the compression rate is realized regarding only the high-frequency components, and ⅛ the compression rate is realized as a whole.

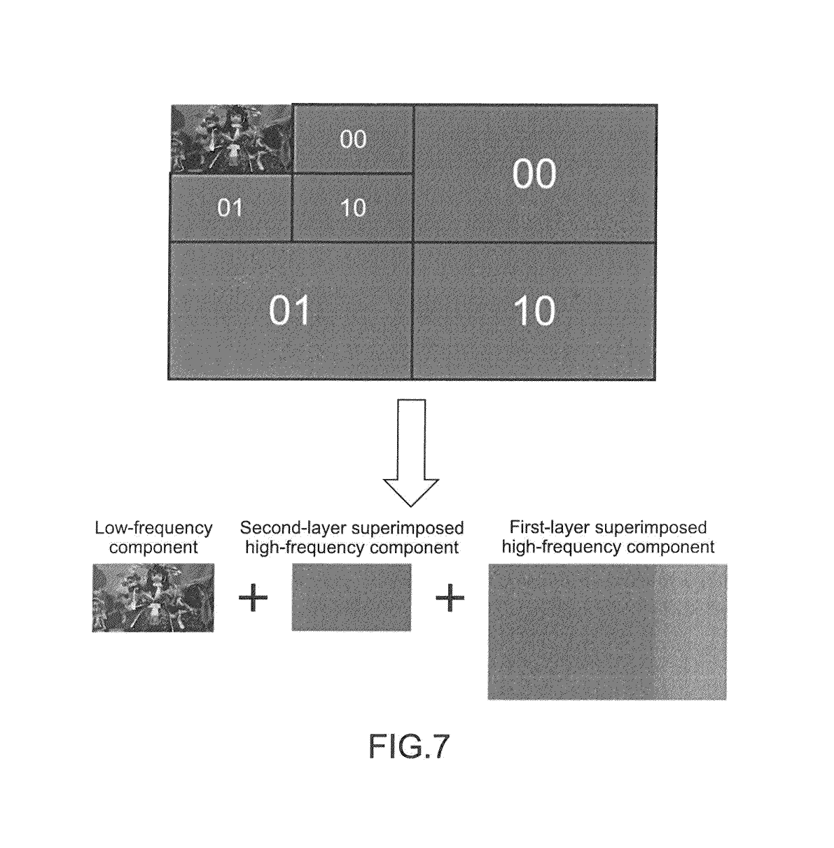

FIG. 7 is a diagram showing another example of the allocation of the area IDs. Also in this example, the wavelet conversion is carried out twice. It should be noted that the superimposition is performed separately for the first-layer high-frequency components as a first processing result and the second-layer high-frequency components as the second processing result. Since the superimposed high-frequency component is obtained for each of the first and second layers in this example and the number of high-frequency components to be superimposed is 3 each, a 2-bit code only needs to be allocated as the area ID.

It should be noted that since different superimposed high-frequency components are generated, the compression rate is ⅜ that is lower than the example shown in FIG. 6. For example, when the original image is of a 4K High-Vision size, the components that remain after the superimposition processing are the first-layer superimposed high-frequency component of the HD size, the second-layer superimposed high-frequency component of ¼ the HD size, and the low-frequency component of ¼ the HD size.

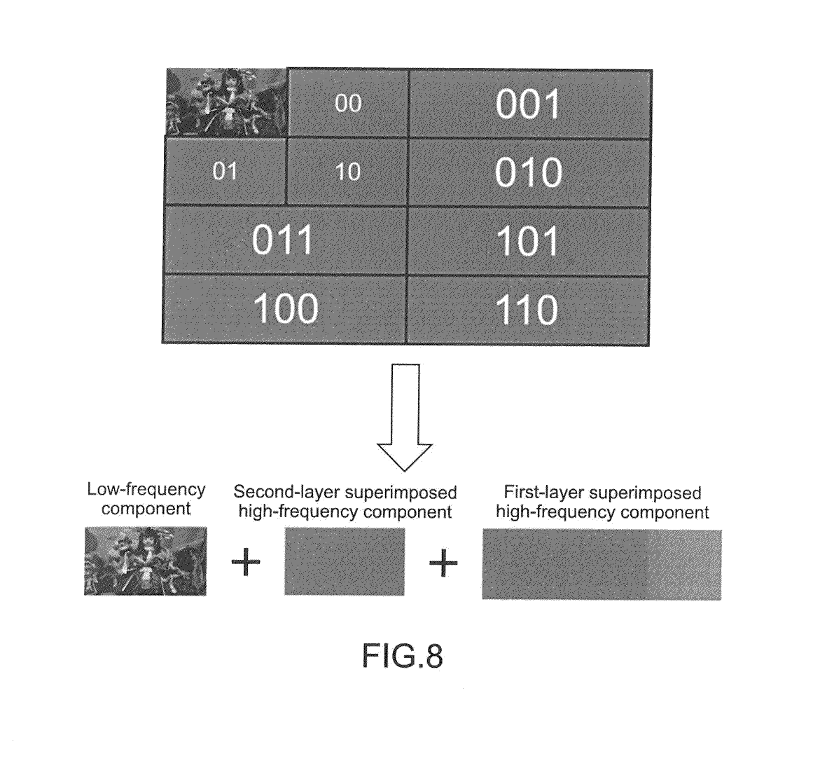

FIG. 8 is an example modified from that shown in FIG. 7. Since the first-layer high-frequency components are divided into half, focusing only on the first-layer high-frequency components, ⅙ compression is being performed. This is because the effect on the image quality is limited even when the compression rate of the first-layer high-frequency components is raised. Further, since the number of areas to be superimposed in the first layer is 6, the bit length of the area ID is 3 bits.

The compression rate is improved from the example shown in FIG. 7 and becomes ¼. For example, when the original image is of a 4K High-Vision size, the components that remain after the superimposition processing are the first-layer superimposed high-frequency component of ½ the HD size, the second-layer superimposed high-frequency component of ¼ the HD size, and the low-frequency component of ¼ the HD size.

(Reprocessing of Scramble and Superimposition)

Next, reprocessing of scramble and superimposition will be described.

In the descriptions on the mechanism of the scramble superimposition encoding, the scramble processing and the superimposition processing are carried out only once. In this case, for example, even when a pixel value of a pixel, that, has moved to coordinates (100, 100) in the LH component and a pixel value of a pixel that has moved to coordinates (100, 100) in the HH component by the scramble processing are non-negligible large values, since values other than the maximum value are thrown away, there is a possibility that the image quality will deteriorate. Moreover, even when all the pixel values in the components to be superimposed are extremely small, since a maximum value is included in the superimposed high-frequency component as a pixel value, there has been a possibility of a poor compression efficiency.

In this regard, in the present disclosure, a structure in which the scramble processing and the superimposition processing are repeated a plurality of times may be adopted.

In the structure in which the scramble processing and the superimposition processing are repeated a plurality of times, the first scramble processing is carried out in a basic manner. When a pixel value of a pixel that, has moved to coordinates (100, 100) in the LH component and a pixel value of a pixel that has moved to coordinates (100, 100) in the HH component are non-negligible large values as in the above example in the first superimposition processing, the maximum value is set as a pixel value at coordinates (100, 100) in the superimposed high-frequency-component image.

A second largest value, for example, a pixel value of a pixel of LH (100, 100) is not thrown away and subjected to the second scramble processing.

A point in performing the scramble processing again is to use a random number table different from that used in the first scramble processing. As a result, the pixel of LH (100, 100) can be moved to LH (69, 100), for example.

The second superimposition processing is carried out after the second scramble processing. The second superimposition processing is carried, out for the pixels at the coordinates (69, 100) of the high-frequency components in the example above.

When non-negligible large pixel values collide with one another as described above, by repeating the scramble processing and the superimposition processing again, the compression can be made without throwing away the large values. It should be noted that a judgment on whether a certain value is a non-negligible large value can be made based on whether the value is equal to or larger than a predetermined threshold value.

Moreover, when all the pixel values of the components to be superimposed are extremely small, by passing over the coordinate position of the superimposed high-frequency component to a reprocessed large value, for example, the compression efficiency can be raised.

It should be noted that an important reminder in performing the reprocessing is to provide a limit to the number of reprocessing times since a code is elongated as the random number table ID used when performing the scramble processing is added to the target pixel every time the reprocessing is carried out.

The reprocessing of the scramble processing and the superimposition processing has been described heretofore.

(Structure of Encoding Apparatus)

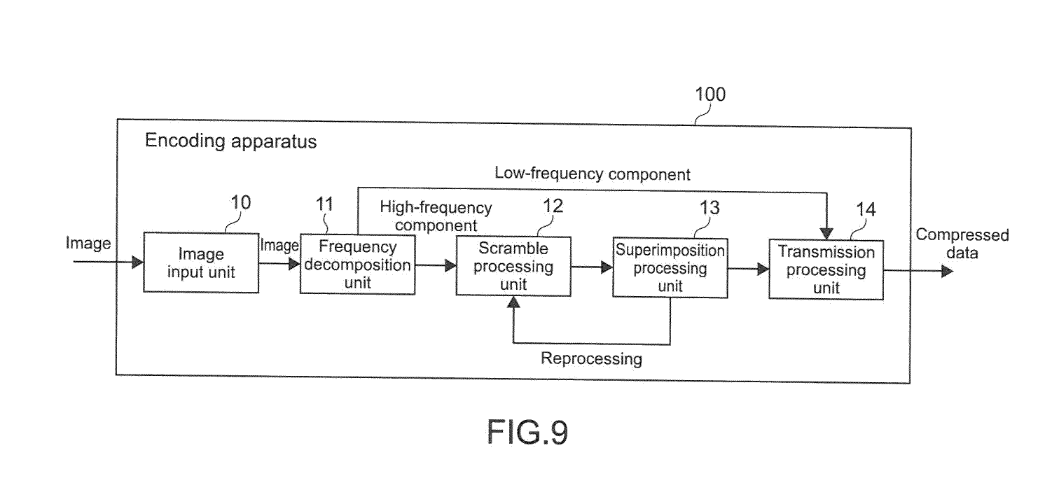

Next, a structure of the encoding apparatus will be described. FIG. 9 is a block diagram showing the structure of the encoding apparatus.

An encoding apparatus 100 includes an image input unit 10, a frequency decomposition unit 11, a scramble processing unit 12, a superimposition processing unit 13, and a transmission processing unit 14.

The image input unit 10 inputs high-resolution image data supplied from an image, pickup apparatus such as a high-resolution camera (not shown) and supplies the image data to the frequency decomposition unit 11.

The frequency decomposition unit 11 decomposes the high-resolution image data supplied from the image input unit 10 into a low-frequency component and high-frequency components using a frequency decomposition algorithm used in a wavelet conversion and the like. For example, in the wavelet conversion, the image data is decomposed into one low-frequency component (LL) and 3 high-frequency components (LK, HL, and HH). It should he noted that the frequency decomposition may be repeated several times so that generation is performed for the frequency components of each layer.

The frequency decomposition unit 11 supplies the low-frequency component obtained by frequency-decomposing the high-resolution image data to the transmission processing unit 14. The frequency decomposition unit 11 also supplies the high-frequency components obtained by frequency-decomposing the high-resolution image data to the scramble processing unit 12.

The scramble processing unit 12 carries out the scramble processing on the high-frequency components supplied from the frequency decomposition unit 11 using the random number table as described above. The scramble processing unit 12 supplies the high-frequency components subjected to the scramble processing to the superimposition processing unit 13.

As described above, the superimposition processing unit 13 carries out the superimposition processing on relevant elements of the scrambled high-frequency components supplied from the scramble processing unit 12. It should be noted that as described above, when there are a plurality of values exceeding a threshold value out of the pixel values of pixels as targets of the superimposition processing, the superimposition processing unit 13 returns the target pixels to the scramble processing unit 12 to again perform the scramble processing and the superimposition processing. The superimposition processing unit 13 supplies the superimposed high-frequency component on which the superimposition processing has been completed appropriately to the transmission processing unit 14.

The transmission processing unit 14 puts together the low-frequency component supplied from the frequency decomposition unit 11 and the superimposed high-frequency component supplied from the superimposition processing unit 13 as compressed data and transmits it to the switch apparatus and the decoding apparatus.

The structure of the encoding apparatus has been described heretofore.

(Flow of Processing of Encoding Apparatus)

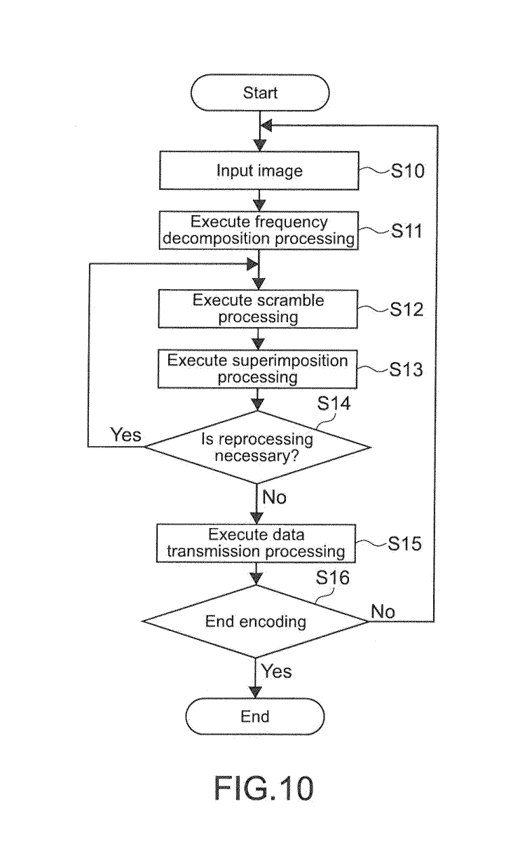

Next, a flow of encoding processing in the encoding apparatus 100 will be described. FIG. 10 is a flowchart showing the flow of the encoding processing in the encoding apparatus 100.

First, the image input unit 10 inputs high-resolution image data supplied from an image pickup apparatus such as a high-resolution camera and supplies the image data to the frequency decomposition unit 11 (Step S10).

Next, the frequency decomposition unit 11 decomposes the high-resolution image data supplied from the image input unit 10 into a low-frequency component and high-frequency components using a frequency decomposition algorithm used in the wavelet conversion and the like (Step S11). The low-frequency component obtained by the frequency decomposition is supplied to the transmission processing unit 14, and the high-frequency components obtained by the frequency decomposition are supplied to the scramble processing unit 12.

Next, the scramble processing unit 12 carries out the scramble processing on the high-frequency components supplied from the frequency decomposition unit 11 (Step S12). The high-frequency components subjected to the scramble processing are supplied to the superimposition processing unit 13.

Subsequently, the superimposition processing unit 13 carries out the superimposition processing on relevant elements of the scrambled high-frequency components supplied from the scramble processing unit 12 (Step S13).

After the superimposition processing, the superimposition processing unit 13 judges whether the scramble processing and the superimposition processing are necessary again as described above (Step S14).

When reprocessing is necessary (Yes in Step S14), the superimposition processing unit 13 returns the processing to the scramble processing unit 12 so that the scramble processing unit 12 carries out the scramble processing again (Step S12) and the superimposition processing unit 13 carries out the superimposition processing again after that (Step S13).

When judged that reprocessing is unnecessary (No in Step S14), the superimposition processing unit 13 supplies the superimposed high-frequency component to the transmission processing unit 14, and the transmission processing unit 14 puts together the low-frequency component supplied from the frequency decomposition unit 11 and the superimposed high-frequency component supplied from the superimposition processing unit 13 as compressed data and transmits the data (Step S15).

The processing from Steps S10 to S15 is repeated while image data is supplied from the image pickup apparatus such as a high-resolution camera (Step S16).

The flow of the encoding processing in the encoding apparatus 100 has been described heretofore.

(Structure of Decoding Apparatus)

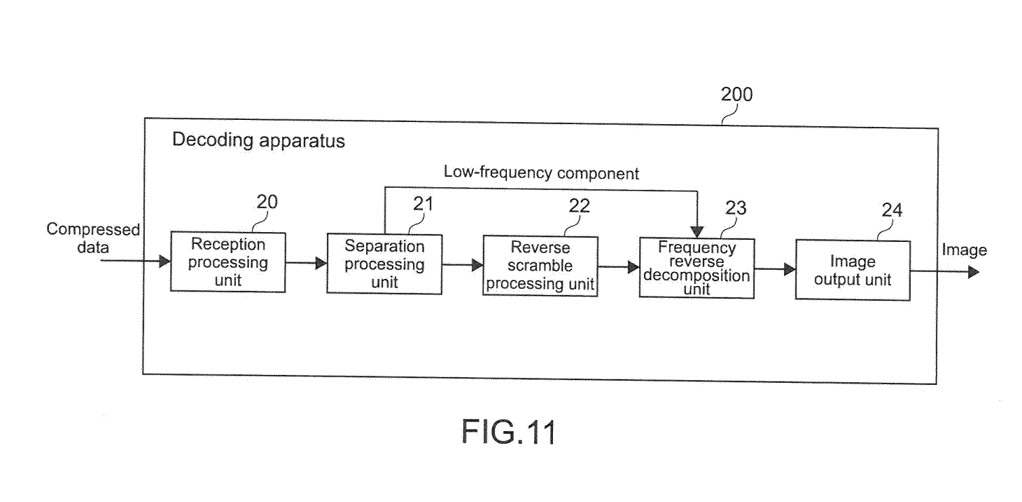

Next, a structure of the decoding apparatus will be described. FIG. 11 is a block diagram showing the structure of the decoding apparatus.

The decoding apparatus 200 includes a reception processing unit 20, a separation processing unit 21, a reverse scramble processing unit 22, a frequency reverse decomposition unit 23, and an image output unit 24.

The reception processing unit 20 receives compressed data transmitted from the encoding apparatus 100 or the switch apparatus and supplies the data to the separation processing unit 21.

The separation processing unit 21 first separates the compressed data supplied from the reception processing unit 20 into a low-frequency component and a superimposed high-frequency component. The separation processing unit 21 supplies the separated low-frequency component to the frequency reverse decomposition unit 23.

The separation processing unit 21 also separates the separated superimposed high-frequency component into individual high-frequency components. Separation into the individual high-frequency components is carried out based on the area IDs added to the pixel values. The separation processing unit 21 supplies the separated individual high-frequency components to the reverse scramble processing unit 22. It should be noted that for the pixel values thrown away in the superimposition processing by the encoding apparatus 100, a predetermined numerical value, for example, 0 may be set as a pixel value at the original position.

The reverse scramble processing unit 22 carries out the reverse scramble processing on the individual high-frequency components supplied from the separation processing unit 21. The reverse scramble processing is processing of restoring a position of a replaced pixel to its original position based on the random number table as described above. By the reverse scramble processing, the reverse scramble processing unit 22 supplies the high-frequency components in which the pixel positions have been restored to the original positions to the frequency reverse decomposition unit 23.

The frequency reverse decomposition unit 23 reversely frequency-decomposes the low-frequency component supplied from the separation processing unit 21 and the individual high-frequency components supplied from the reverse scramble processing unit 22 using a frequency reverse decomposition algorithm used in the wavelet conversion and the like, and synthesizes the image data. The frequency reverse decomposition unit 23 supplies the synthesized image data to the image output unit 24.

The image output unit 24 outputs the image data supplied from the frequency reverse decomposition unit 23 to a display apparatus such as a monitor.

The structure of the decoding apparatus has been described heretofore.

(Flow of Processing in Decoding Apparatus)

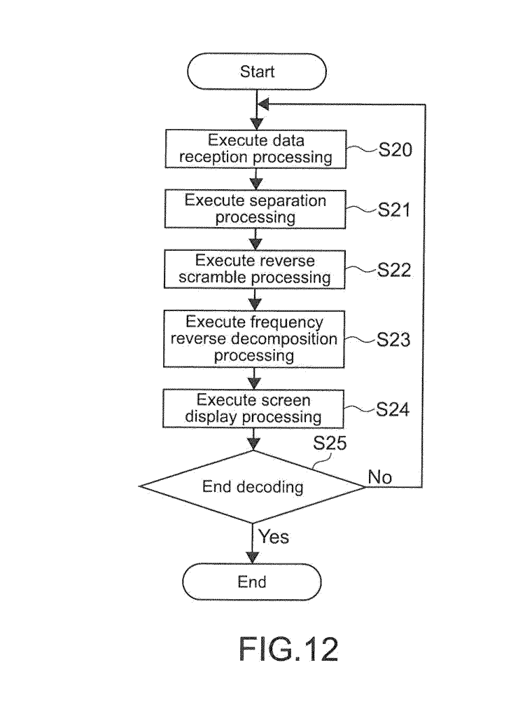

Next, a flow of decoding processing in the decoding apparatus 200 will be described. FIG. 12 is a flowchart showing the flow of the decoding processing in the decoding apparatus 200.

First, the reception processing unit 20 receives compressed data transmitted from the encoding apparatus 100 or the switch apparatus (Step S20). The received compressed data is supplied to the separation processing unit 21.

Next, the separation processing unit 21 separates the compressed data supplied from the reception processing unit 20 into a low-frequency component and a superimposed high-frequency component. The separation processing unit 21 supplies the separated low-frequency component to the frequency reverse decomposition unit 23. The separation processing unit 21 additionally separates the separated superimposed high-frequency component into individual high-frequency components (Step S21). The separated individual high-frequency components are supplied to the reverse scramble processing unit 22.

Subsequently, the reverse scramble processing unit 22 carries out reverse scramble processing on the individual high-frequency components supplied from the separation processing unit 21 (Step S22).

Then, the frequency reverse decomposition unit 23 reversely frequency-decomposes the low-frequency component supplied from the separation processing unit 21 and the individual high-frequency components supplied from the reverse scramble processing unit 22 using the frequency reverse decomposition algorithm used in the wavelet conversion and the like, and synthesizes the image data (Step S23). The synthesized image data is supplied to the image output unit 24.

Next, the image output unit. 24 outputs the image data supplied from the frequency reverse decomposition unit 23 to the display apparatus such as a monitor (Step S24).

The flow of the decoding processing in the decoding apparatus 200 has been described heretofore.

(Structure of Switch Apparatus)

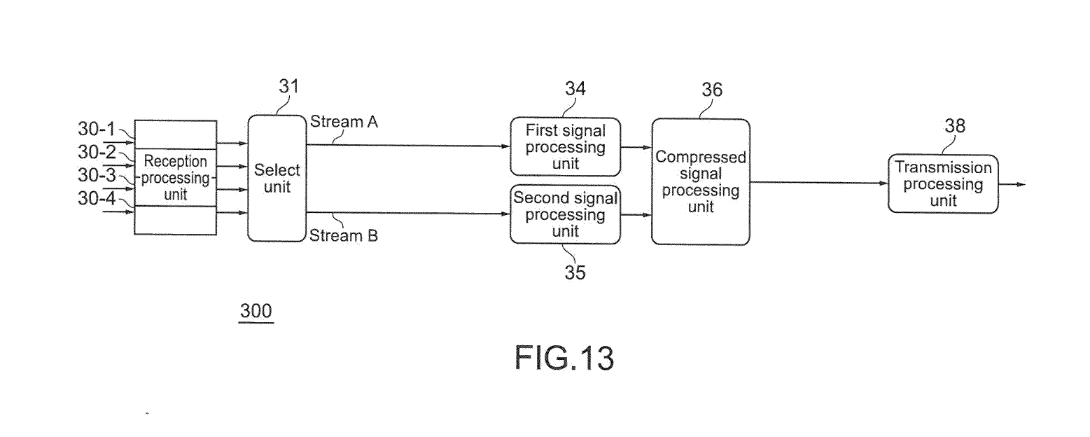

Next, a structure of the switch apparatus will be described. FIG. 13 is a block diagram showing the structure of the switch apparatus according to the present disclosure.

The switch apparatus 300 of the present disclosure includes reception processing units 30-1 to 30-4, a select unit 31, a first signal processing unit 34, a second signal processing unit 35, a compressed signal processing unit 36, and a transmission processing unit 38.

The plurality of reception processing units 30-1 to 30-4 receive, when there ax-e a plurality of encoding apparatuses 100, a plurality of pieces of compressed image data compression-coded by the encoding apparatuses 100 and supply them to the select unit 31, for example.

The select unit 31 selects the compressed image data to be transmitted to the subsequent units from the plurality of pieces of compressed image data. Here, a case where two images (streams A and B) are selected from 4 pieces of compressed image data will be discussed. One image (stream A) is supplied to the first signal processing unit 34, and the other image (stream B) is supplied to the second signal processing unit 35.

The first signal processing unit 34 carries out signal processing on the compressed image (stream A) supplied from the select unit 31. A result of the signal processing is supplied to the compressed signal processing unit 36. It should be noted that the signal processing that can be carried out in this case is processing that is carried out uniformly on the images. Specific examples of the signal processing include a white balance adjustment, a black balance adjustment, a flare adjustment, a saturation adjustment, a matrix adjustment, a gamma adjustment, a knee adjustment, and a whine clip adjustment.

The second signal processing unit 35 also carries out signal processing like the first signal processing unit 34 and supplies the processing result to the compressed signal, processing unit 36.

The compressed signal processing unit 36 carries out signal processing of synthesizing two pieces of compressed image data respectively supplied from the first signal processing unit 34 and the second signal processing unit 35 into one compressed image data. Specific examples of the signal processing include MIX processing, PinP processing, WIPE processing, Chroma key processing, Luminance key processing, and logo and caption insertion processing.

In carrying out the signal processing for an image synthesis, the compressed signal processing unit 36 separates the supplied compressed image data into a low-frequency component, a superimposed high-frequency component, and a boundary component and carries out image processing (to be described later) in a scramble-superimposition-encoded state. It should be noted that the boundary component is a portion corresponding to a boundary portion of two images in the image synthesis processing and is a portion where the image processing is to be carried out locally and accurately.

The compressed image data that has been subjected to the signal processing by the compressed signal processing unit 36 is supplied to the transmission processing unit 38.

The transmission processing unit 38 transmits the compressed image data supplied from the compressed signal processing unit 36 to the decoding apparatus 200.

The structure of the switch apparatus 300 has been described heretofore.

(Comparison of Hardware Structure with Related Art)

Next, to confirm that the hardware resources are downsized as compared to the related art by the scramble superimposition encoding of the present disclosure, a difference in the hardware structure between the switch apparatus 300 of the present disclosure and a switch apparatus of the related art (Huffman coding) will be described.

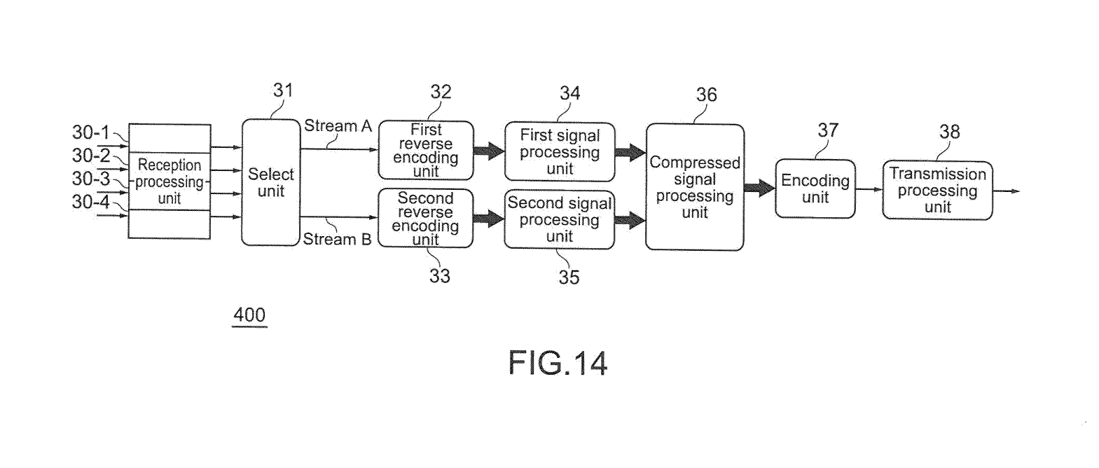

FIG. 14 is a block diagram showing a structure of a switch apparatus 400 of the related art. The switch apparatus 400 is different from the switch apparatus 300 of the present disclosure shown in FIG. 13 in that a first reverse encoding unit 32 is provided between the select unit 31 and the first signal processing unit 34, and a second reverse encoding unit 33 is similarly provided between the select unit 31 and the second signal processing unit 35. In addition, an encoding unit 37 is provided between the compressed, signal processing unit 36 and the transmission processing unit 38.

Specifically, the three hardware blocks of the first reverse encoding unit 32, the second reverse encoding unit 33, and the encoding unit 37, that have been necessary in the switch apparatus 400 of the related art that uses Huffman coding, are omitted in the present disclosure.

Moreover, since data is transmitted as compressed data among the blocks in the switch apparatus 300 of the present disclosure, data can all be transmitted at 3 Gbps, for example. In contrast, in the switch apparatus 400 of the related art, signal processing is carried out after the reverse encoding as indicated by bold arrows in the figure, and a data flow rate becomes, for example, 12 Gbps among the blocks before re-encoding.

Specifically, according to the present disclosure, a communication path having a large bandwidth, that has been necessary in the switch apparatus 400 of the related art that uses Huffman coding, is unnecessary.

The difference in the hardware structure between the switch apparatus 300 of the present disclosure and the switch apparatus 400 of the related art has been described heretofore,

(Regarding Image Processing in Scramble-Superimposition-Encoded-State)

Next, the signal processing for an image synthesis that is carried out by the compressed signal processing unit 36 of the switch apparatus 300 in a state where image data is scramble-superimposition-encoded will be described in detail.

In the compressed signal processing unit 36, the image processing is carried out on the compressed image data separately for the low-frequency component, the superimposed high-frequency component, and the boundary component.

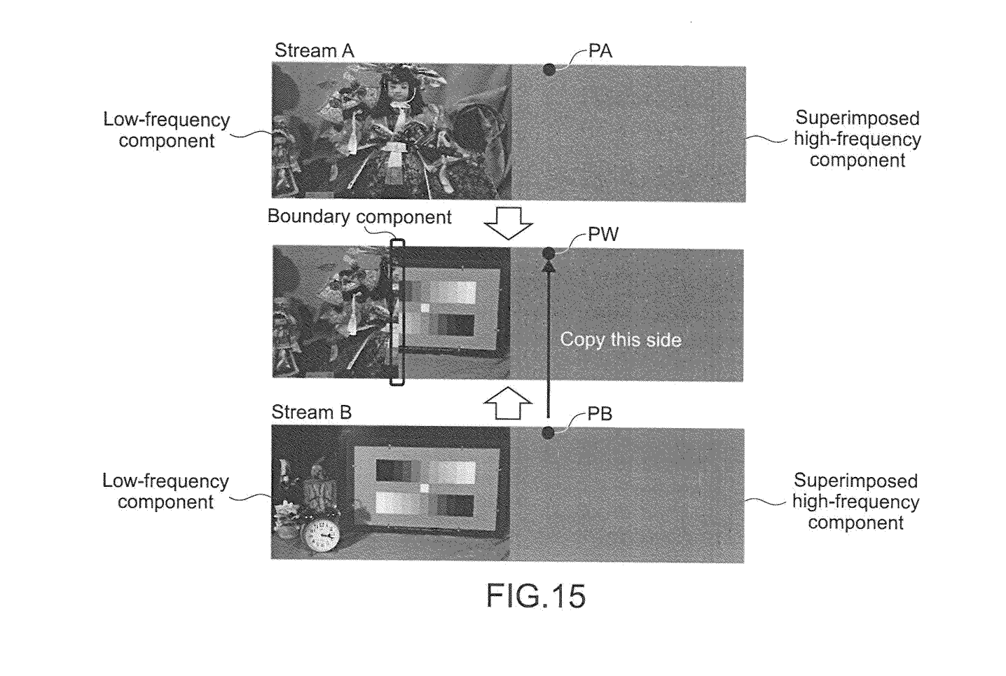

FIG. 15 is a diagram showing a positional relationship of the components when performing WIPE processing as the image processing. First, an Image of a size corresponding to 2 HDs on the upper side of the figure is a compressed image of the stream A, and an image of a size corresponding to 2 HDs on the lower side of the figure is a compressed image of the stream B. The compressed images are synthesized by the WIPE processing to thus become a compressed image of a size corresponding to 2 HDs in the middle of the figure.

In the figure, images each of a size corresponding to one HD on the left-hand side of the compressed images of the streams A and B are low-frequency-component images, and contents thereof can be checked visually (it can be seen that a doll, clock, and the like are displayed).

(Processing of Low-Frequency Component)

By carrying out the same processing as the WIPE processing in a normal non-compression state, that is, in a baseband, low-frequency-component images are synthesized.

(Processing of Superimposed High-Frequency Component)

Further, images each of a size corresponding to one HD on the right-hand side of the compressed images of the streams A and B are superimposed high-frequency-component images. The superimposed high-frequency-component images are like gray noises since high-frequency components separated from the original image by the wavelet conversion are subjected to the scramble processing.

The superimposed high-frequency-component images are subjected to the same WIPE processing as that performed with respect to the baseband while assuming that there is a pixel at original coordinates after specifying the original coordinates of the pixel using the reverse random number table Rev_Rand for each pixel.

For example, when there are a pixel PA included in the superimposed high-frequency component of the stream A and a pixel PB included in the superimposed high-frequency component of the stream B in the figure, which of the pixels is to remain after the image processing by the WIPE processing is judged based on the pixel coordinates obtained before the scramble processing.

In the example shown in the figure, since the original coordinates of the pixel PB indicate the pixel to be left after the WIPE processing, a value of the pixel PB is copied, to a pixel PW in the superimposed high-frequency component after the WIPE processing.

(Processing of Boundary Component)

A boundary portion where the images of the streams A and B are switched in the low-frequency-component image on the left-hand side of the compressed image in the middle of the figure is a boundary component appearing in the low-frequency component. Although the boundary component is also included in the image on the superimposed high-frequency component side, due to the scramble processing, the position cannot be illustrated in the figure.

To carry out the WIPE processing of the boundary component, the same WIPE processing as that performed with respect to a baseband is carried out after subjecting the boundary component to a wavelet reverse conversion once so as to synthesize the low-frequency component and the superimposed high-frequency component, and restoring the image as much as possible to a state close to the original image. Then, the image is subjected to the wavelet conversion and the scramble processing again.

As can be understood from the example above, while an operation needs to be executed with respect to image information corresponding to 8 HD-size images when the WIPE processing in the baseband is carried out as in the related art, according to the present disclosure, an operation amount can be suppressed to an amount corresponding to 4 HD-size images by directly carrying out image processing on a compressed image basis.

Heretofore, the signal processing for an image synthesis that is carried, out by the compressed signal processing unit 36 of the switch apparatus 300 in a state where image data is scramble-superimposition-encoded has been described in detail.

(Flow of Processing in Compressed Signal Processing Unit 36)

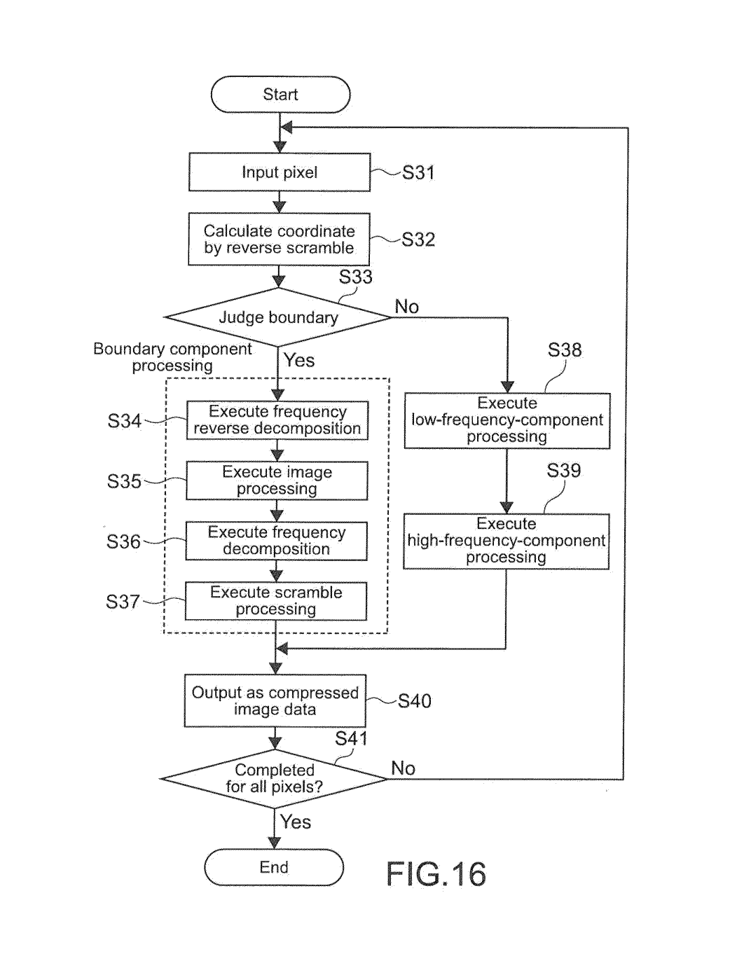

Next, a flow of processing in the compressed signal processing unit 36 will be described. FIG. 16 is a flowchart showing the flow of the processing in the compressed signal processing unit 36.

First, the compressed signal processing unit 36 takes out processing target pixels from compressed image data supplied from the first signal processing unit 34 and the second signal processing unit 35 (Step S31). When a Haar wavelet conversion is performed once in performing the encoding processing, pixels in a 2×2 area are taken out. When the Haar wavelet, conversion is performed twice, pixels in a 4×4 area are taken out.

Next, the compressed signal processing unit 36 specifies a reverse random number table Rev_Rand requisite for the reverse scramble processing based on the random number table ID added to each pixel and calculates original coordinates of each pixel from before the scramble processing (Step S32).

Then, the compressed signal processing unit 36 judges whether the pixel is a pixel in the vicinity of a boundary based on the calculated original coordinates (Step S33).

When judged that the pixel is a pixel in the vicinity of a boundary, that is, a boundary component (Yes in Step S33), the compressed signal processing unit 36 carries out a wavelet reverse conversion on the target pixel (Step S34).

Subsequently, the compressed signal processing unit 36 carries out image processing such as the WIPE processing (Step S35) and carries out the wavelet conversion on the pixel subjected to the image processing (Step S36). Next, the compressed signal processing unit 36 carries out the scramble processing on the pixel subjected to the wavelet conversion. The processing from Steps S34 to S37 is the processing of the boundary component.

When judged that the pixel is not a pixel in the vicinity of a boundary, that is, not a boundary component in Step S33 (No in Step S33), the compressed signal processing unit 36 carries out image processing such as the WIPE processing on the low-frequency component (Step S38) and carries out the image processing as described above on the superimposed high-frequency component (Step S39).

Next, the compressed signal processing unit 36 outputs, as compressed image data to be a synthetic Image, the boundary component subjected to the scramble processing in Step S37, the low-frequency component subjected to the image processing in Step S38, and the superimposed high-frequency component subjected to the image processing in Step S39 (Step S40).

The compressed signal processing unit 36 repeats the processing described above until the processing is completed for all pixels (Step S41).

The flow of the processing of the compressed signal processing unit 36 has been described heretofore.

(Supplementary Note)

It should be understood by those skilled in the art that various modifications, combinations, sub-combinations and alterations may occur depending on design requirements and other factors insofar as they are within the scope of the appended claims or the equivalents thereof.

What is claimed is:

1. An encoding apparatus, comprising:
a frequency decomposition unit configured to frequency-decompose image data into a low-frequency-component image and a plurality of high-frequency-component images;
a superimposition processing unit configured to superimpose the plurality of frequency-decomposed high-frequency-component images to generate a single superimposed high-frequency-component image; and
a transmission unit configured to transmit the low-frequency-component image and the superimposed high-frequency-component image as compressed image data.

2. The encoding apparatus according to claim 1,
wherein the superimposition processing unit performs the superimposition after selecting, out of the plurality of high-frequency-component images, a maximum value among relevant pixels as a pixel value of the superimposed high-frequency-component image.

3. The encoding apparatus according to claim 2, further comprising
a scramble processing unit configured to perform scramble processing on each of the plurality of frequency-decomposed high-frequency-component images.

4. The encoding apparatus according to claim 3,
wherein the scramble processing unit performs the scramble processing by replacing, according to mutually-different rules respectively allocated to the plurality of frequency-decomposed high-frequency-component images, a pixel position in. the high-frequency-component image.

5. The encoding apparatus according to claim 4,
wherein the superimposition processing unit performs, when there are a plurality of values equal to or larger than a predetermined threshold value among values of the relevant pixels, the superimposition after selecting a maximum value as a pixel value of the superimposed high-frequency-component image and subjecting the rest of the values equal to or larger than the threshold value to the scramble processing again by the scramble processing unit.

6. A decoding apparatus, comprising:
an input unit configured to input compressed image data transmitted from an encoding apparatus including
a frequency decomposition unit that frequency-decomposes image data into a low-frequency-component image and a plurality of high-frequency-component images,
a superimposition processing unit that superimposes the plurality of frequency-decomposed high-frequency-component images to generate a single superimposed high-frequency-component, image, and
a transmission unit that transmits the low-frequency-component image and the superimposed high-frequency-component image as the compressed image data;
a separation processing unit configured to separate the input compressed image data into the low-frequency-component image and the superimposed high-frequency-component image;
a reverse superimposition processing unit configured to subject the separated superimposed high-frequency-component image to reverse superimposition processing to obtain the plurality of high-frequency-component images;
a frequency reverse decomposition unit configured to reversely frequency-decompose the separated low-frequency-component image and the plurality of high-frequency-component images obtained by the reverse superimposition processing; and
an output unit configured to output image data generated by the frequency reverse decomposition.

7. A switch apparatus, comprising:
an input unit configured to input a plurality of pieces of compressed image data transmitted from a plurality of encoding apparatuses each including
a frequency decomposition unit that frequency-decomposes image data into a low-frequency-component image and a plurality of high-frequency-component images,
a superimposition processing unit that superimposes the plurality of frequency-decomposed high-frequency-component images to generate a single-superimposed high-frequency-component image, and
a first transmission unit that transmits the low-frequency-component image and the superimposed high-frequency-component image as the compressed image data;
a select unit configured to select a plurality of pieces of compressed image data from the plurality of pieces of input compressed image data;
a signal processing unit configured to perform processing for a synthesis on the plurality of selected pieces of compressed image data; and
a second transmission unit configured to transmit the processed compressed image data.

8. The switch apparatus according to claim 7,
wherein the signal processing unit separates the compressed image data into the low-frequency component, the superimposed high-frequency component, and a boundary component that is obtained when synthesizing images included in the plurality of pieces of compressed image data, and performs the processing for a synthesis for each of the components.

9. The switch apparatus according to claim 8,
wherein the plurality of encoding apparatuses each include a scramble processing unit that replaces, according to mutually-different rules respectively allocated to the plurality of frequency-decomposed high-frequency-component images, a pixel position in the high-frequency-component image, and
wherein the signal processing unit performs the processing for a synthesis by specifying, with respect to the plurality of superimposed high-frequency-component images, the pixel position from before the scramble processing using the rules,

10. The switch apparatus according to claim 8,
wherein the signal processing unit performs the scramble processing by performing frequency reverse decomposition processing on the boundary component, performing the processing for a synthesis as in a case of a baseband, and performing the frequency decomposition again.
